(19) United States
(12) Patent Application Publication
(10) Pub. No.: US 2004/0259606 A1
(43) Pub. Date: Dec. 23, 2004

(54) Key button device for portable communication terminal

(75) Inventors: Jong-Cheon Wee, Yongin-shi (KR); Jae-Shik Kim, Seoul (KR); Kee-Dug Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/862,262

(22) Filed: Jun. 7, 2004

(30) Foreign Application Priority Data
Jun. 20, 2003 (KR) 40294/2003

(51) Int. Cl. H04Q 7/20

(52) U.S. Cl. 455/575.1; 455/90.3

(57) ABSTRACT

Disclosed herein is a key button device for a portable communication terminal, the device having a plurality of key buttons provided with corresponding key support parts, thereby preventing malfunction of the key buttons. The key button device includes at least one key part attached to a casing frame of the portable communication terminal, at least one switch part mounted on a printed circuit board in the casing frame, and at least one key support part attached to the key part and coupled with the switch part while the key support part surrounds the switch part.

### PRIORITY

This application claims priority to an application entitled “KEY BUTTON DEVICE FOR PORTABLE COMMUNICATION TERMINAL”, filed in the Korean Intellectual Property Office on Jun. 20, 2003 and assigned Serial No. 2003-40294, the contents of which are hereby incorporated by reference.

### BACKGROUND OF THE INVENTION

1. Field of the Invention

The present invention relates to a key button device for a portable communication terminal, and more particularly to a key button device for a portable communication terminal, which comprises a plurality of key buttons provided with corresponding key support parts.

2. Description of the Related Art

Generally, “portable communication devices” means devices that are portable and enable owners of the devices to communicate in a wireless way. Such portable communication devices generally include a HHP, a CT-2 cellular phone, a digital phone, a PCS phone, a PDA, etc. On the basis of their forms, for example, the portable communication devices may be classified into a bar-type wireless communication terminal, a flip-type wireless communication terminal, and a folder-type wireless communication terminal. The bar-type wireless communication terminal has a single housing, the flip-type wireless communication terminal comprises a bar-type housing and a flip part pivotably attached to the housing, and the folder-type wireless communication terminal comprises a bar-type housing and a folder part pivotably attached to the housing. Each of the aforesaid conventional portable communication devices essentially includes an antenna, data input/output units, and data transmitting/receiving units. Usually, the data input unit is a key button device that a user presses with his or her fingers to input data. A touch screen may also be used.

The key button device is also used to provide the data input required to transmit/receive text messages.

The key button device, which is used to input data, is basically made up of an array of several keys. The keys include, for example, a send key (SND), which is a communication start key, a cancel key, a clear key (CLR), numeric keys, letter keys, an end key (END), functional keys, and a power on/off key (PWR).

The key button device comprises a keypad provided on the front surface of the portable communication terminal, and a plurality of side keys, which support the operation of the keypad and simultaneously serves as function keys.

The side keys of the key button device make direct contact with metal domes, which are connecting members mounted inside the portable communication terminal, when the side keys are made of rubber. Alternatively, each of the side keys may be engaged with a tact switch made up of a plastic molded part and a rubber part connected to the plastic molded part according to various desires of users.

Referring to FIGS. 1 to 4, there are shown side keys of a conventional key button device for a portable communication device. The side keys are attached to a casing frame 1 of the portable communication device while they are protruded outwardly.

On the casing frame 1 is provided a printed circuit board 2, for example, a RF board. On the printed circuit board 2 are mounted tact switches 4, which make contact with the rear surfaces of the side keys 3, respectively.

The tact switches 4 are provided with contact pieces 4a, which make contact with the rear surfaces of the side keys 3, respectively.

One of the side keys 3, which is provided at one side of the casing frame 1, is attached to a rubber contact part 3a. The other of the side keys 3, which is provided at the other side of the casing frame 1, is attached to a hinge part 3b in such a manner that the side key 3 can be pivotably rotated about the hinge part 3b.

The side keys are attached to the casing frame 1, and the tact switches 4 are individually mounted on the printed circuit board 2.

When the portable communication terminal is assembled while the printed circuit board 2 is biased to the right or the left, the tact switches 4 mounted on the printed circuit board 2 are biased accordingly. As a result, the tact switches 4 make tight contact with the side key 3 provided at one side of the casing frame 1. On the other hand, the tact switches 4 make loose contact with the side key 3 provided at the other side of the casing frame 1. Consequently, there exists a gap F1 between the tact switch 4 and the side key 3 with the result that a pressing operation of the keys is not smoothly carried out, tactile sensation of clicking keys is poor, and therefore malfunction of the portable communication terminal may be caused.

### SUMMARY OF THE INVENTION

Therefore, the present invention has been made in view of the above problem, and it is an object of the present invention to provide a key button device for a portable communication terminal wherein key buttons of the key button device are provided with corresponding key support parts, whereby a pressing operation of the key buttons is smoothly carried out, tactile sensation of clicking the key buttons is good, and therefore malfunction of the key buttons is prevented.

It is another object of the present invention to provide a key button device for a portable communication terminal wherein side keys of the key button device are provided with corresponding key support parts, whereby a pressing operation of the side keys is smoothly carried out, tactile sensation of clicking the side keys is good, and therefore malfunction of the side keys is prevented.

In accordance with one aspect of the present invention, the above and other objects can be accomplished by the provision of a key button device equipped in a casing frame of a portable communication terminal, comprising: at least one key part attached to the casing frame; at least one switch part mounted on a printed circuit board in the casing frame; and at least one key support part attached to the key part and coupled with the switch part while the key support part surrounds the switch part.

In accordance with another aspect of the present invention, there is provided a key button device equipped in a casing frame of a portable communication terminal, comprising: at least one key part attached to the casing frame; at least one switch part mounted on a printed circuit board in the casing frame; and at least one key support part detachably attached to the key part and coupled with the switch part while the key support part surrounds the switch part.

In accordance with yet another aspect of the present invention, there is provided a key button device equipped in a casing frame of a portable communication terminal, comprising: at least two key parts attached to both sides of the casing frame, respectively; at least two switch parts mounted on a printed circuit board in the casing frame; and at least two key support parts attached to the key parts and coupled with the switch parts while the key support parts surround the switch parts, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of side keys of a conventional key button device for a portable communication terminal;

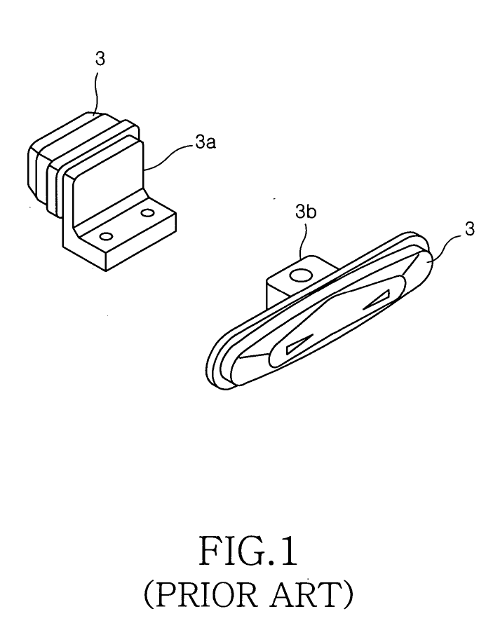

FIG. 2 is a perspective view showing the side keys of the conventional key button device attached to a portable communication terminal;

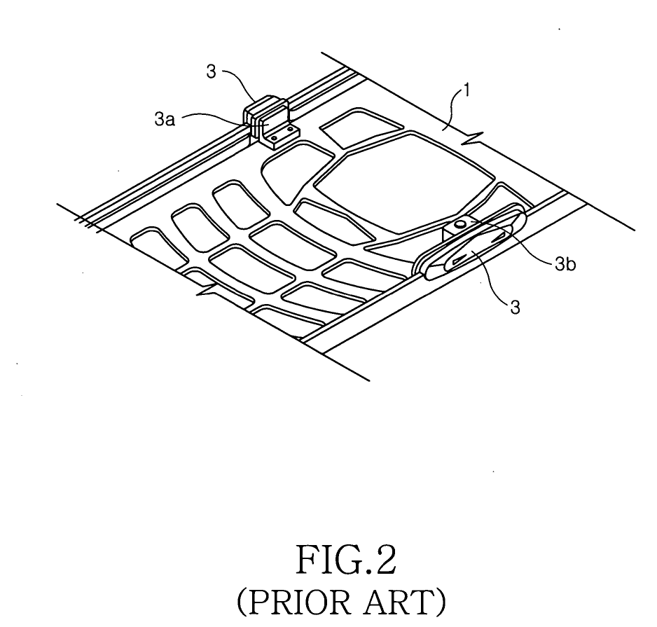

FIG. 3 is a perspective view showing the side keys of the conventional key button device engaged with tact switches;

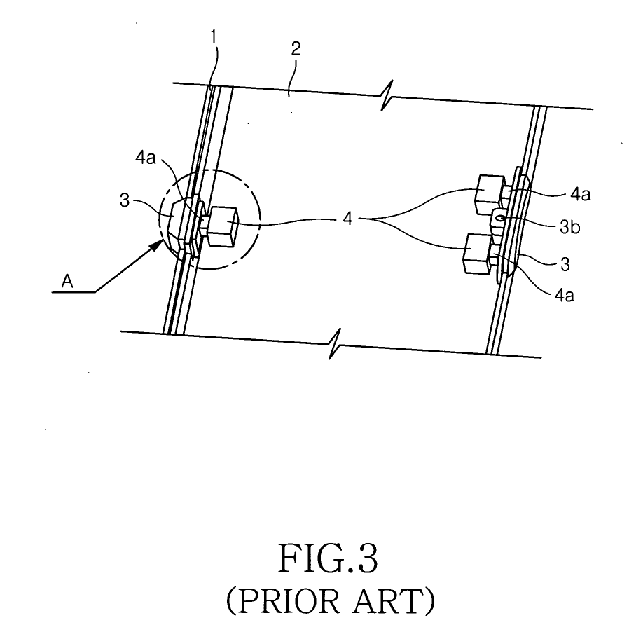

FIG. 4 is an enlarged perspective view of the A portion of FIG. 3;

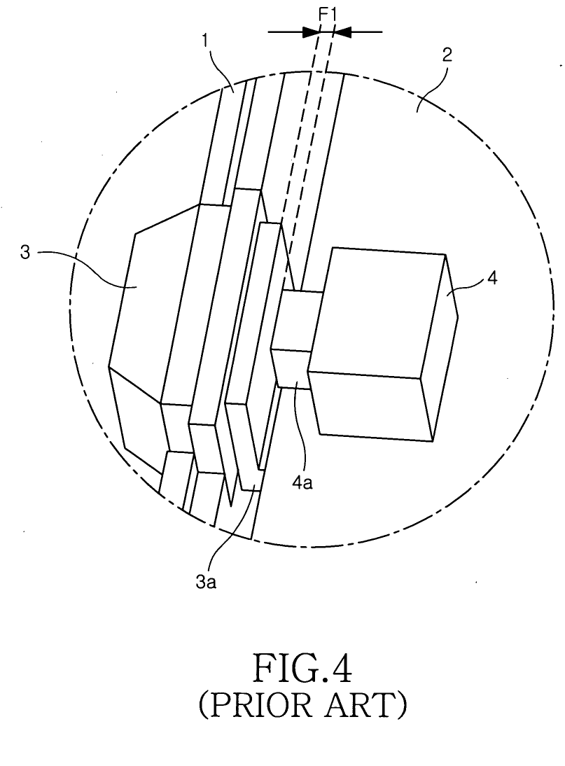

FIG. 5 is a partial exploded perspective view of one part of a key button device for a portable communication device according to a first preferred embodiment of the present invention;

FIG. 6 is a partial exploded perspective view of the other part of a key button device for a portable communication device according to a first preferred embodiment of the present invention;

FIG. 7 is an assembled perspective view of a key button device for a portable communication device according to a first preferred embodiment of the present invention;

FIG. 8 is an enlarged perspective view of the B portion of FIG. 7;

FIG. 9 is an enlarged perspective view of the C portion of FIG. 7;

FIG. 10 is a perspective view of a key button device for a portable communication device according to a second preferred embodiment of the present invention; and

FIG. 11 is a perspective view of a key button device for a portable communication device according to a third preferred embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings.

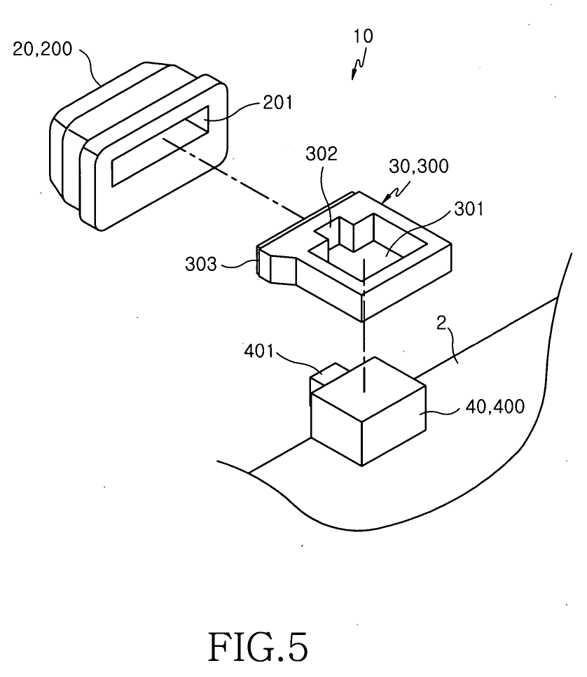

Referring to FIGS. 5 to 9, there is shown a key button device 10 for a portable communication device according to a first preferred embodiment of the present invention. The key button device 10 comprises at least one key part 20, at least one key support part 30, and at least one switch part 40. The key part 20 is attached to a casing frame 1 of the portable communication device. The switch part 40 is mounted on a printed circuit board 2 in the casing frame 1. The key support part 30 is attached to the key part 20. Also, the key support part 30 is coupled with the switch part 40 while the key support part 30 surrounds the switch part 40. The key part 20 comprises a keypad and side keys, which the person operating the portable communication terminal uses to input data. The key support part 30 is preferably made of rubber.

The operation of the key button device according to the first preferred embodiment of the present invention with the above-stated construction will now be described in detail with reference to FIGS. 5 to 9.

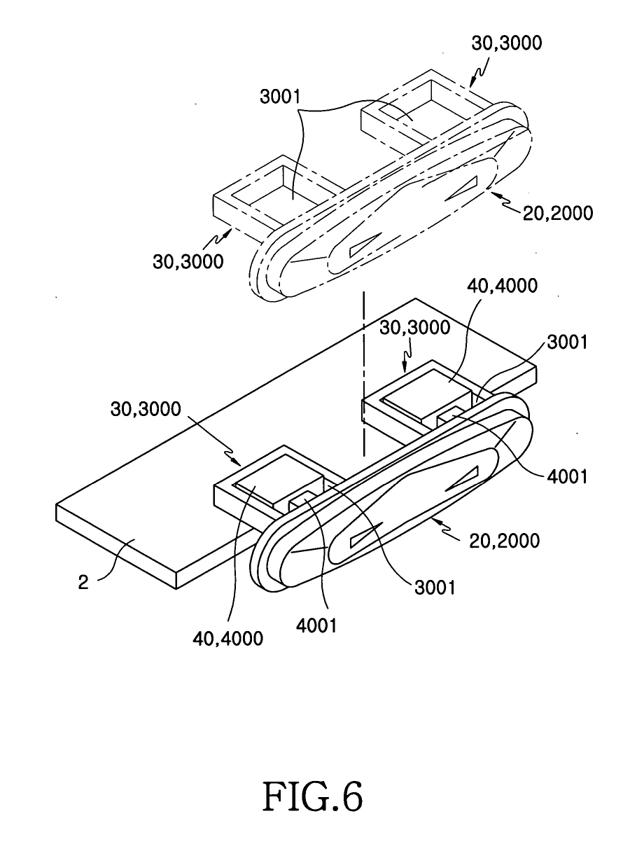

As shown in FIGS. 5 and 6, the switch part 40 is mounted on the printed circuit board 2 in the casing frame 1 of the portable communication terminal so that the key part 20 or 200 can be attached to the switch part 40.

As mentioned above, the key part 20 or 200 comprises the keypad and the side keys.

Hereinafter, only the side keys of the key part 20 or 200 will be described.

As shown in FIG. 5, the key support part 30 or 300 is provided with an engagement portion 303, which is detachably engaged into an engagement hole 201 of the rear surface of the key part 20 or 200. Consequently, the key support part 30 or 300 is attached to the key part 20 or 200 by inserting the engagement portion 303 of the key support part 30 or 300 into the engagement hole 201 of the key part 20 or 200.

The key support part 30 or 300 is also provided with an engagement hole 301, into which the switch part 40 or 400 is engaged. Consequently, the switch part 40 or 400 is engaged with the key support part 30 or 300 by inserting the switch part 40 or 400 into the engagement hole 301 of the key support part 30 or 300.

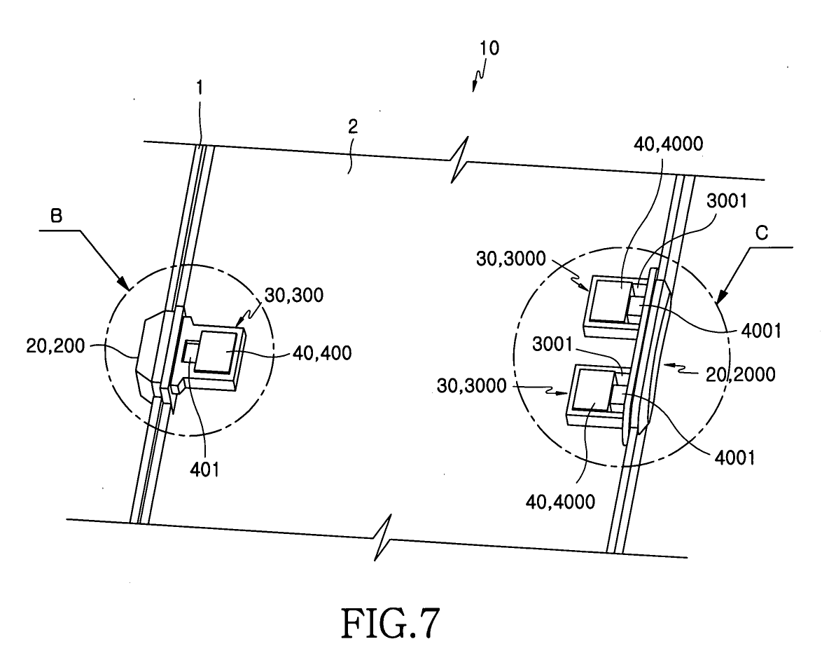

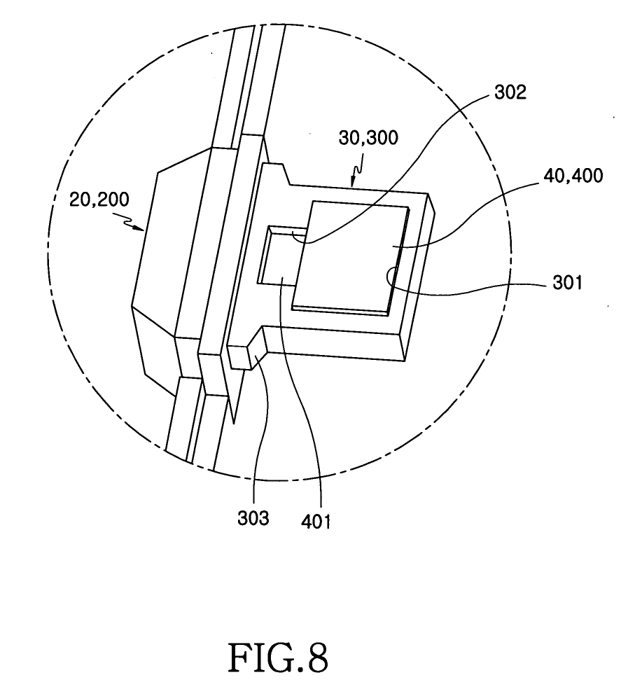

As shown in FIGS. 7 and 8, the switch part 40 or 400 is mounted at one side of the printed circuit board 2, and the key support part 30 or 300 is coupled with the switch part 40 or 400 while the key support part 30 or 300 surrounds the switch part 40 or 400.

The key support part 30 or 300 is provided with an insertion hole 302, into which an insertion portion 401 of the switch part 40 or 400 is inserted.

Similarly, the switch parts 40 or 4000 are also mounted at the other side of the printed circuit board 2, and the key support parts 30 or 3000, which are formed integrally with the key parts 20 or 2000, are coupled with the switch parts 40 or 4000 while the key support parts 30 or 3000 surround the switch parts 40 or 4000, respectively.

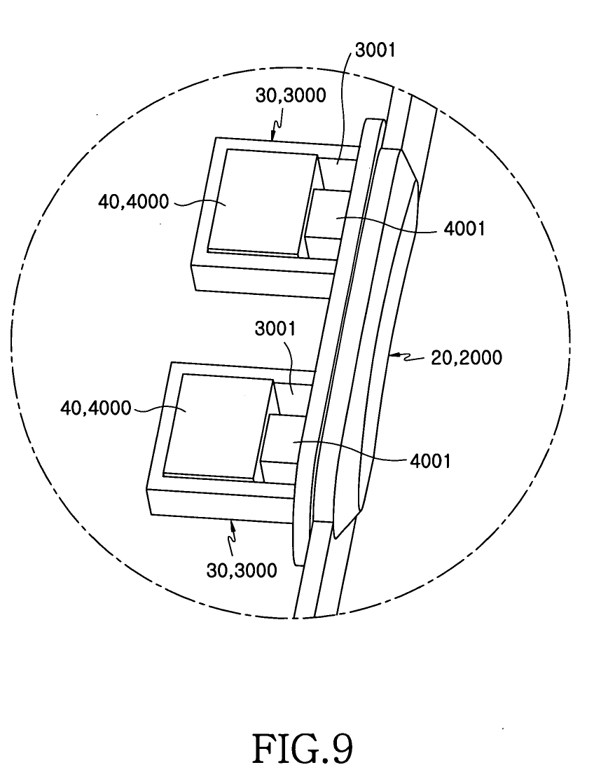

As shown in FIG. 9, the key support parts 3000 are provided with engagement holes 3001, into which the switch parts 4000 are engaged, respectively.

Insertion portions 4001 of the switch parts 4000 are also inserted into the engagement holes 3001 of the key support parts 3000, respectively.

As described above, the key parts 20 or 200 are tightly attached to the switch parts 40 or 4000 by means of the key support parts 30 or 300, respectively, whereby the switch parts 40 or 4000 are not biased to the right or to the left.

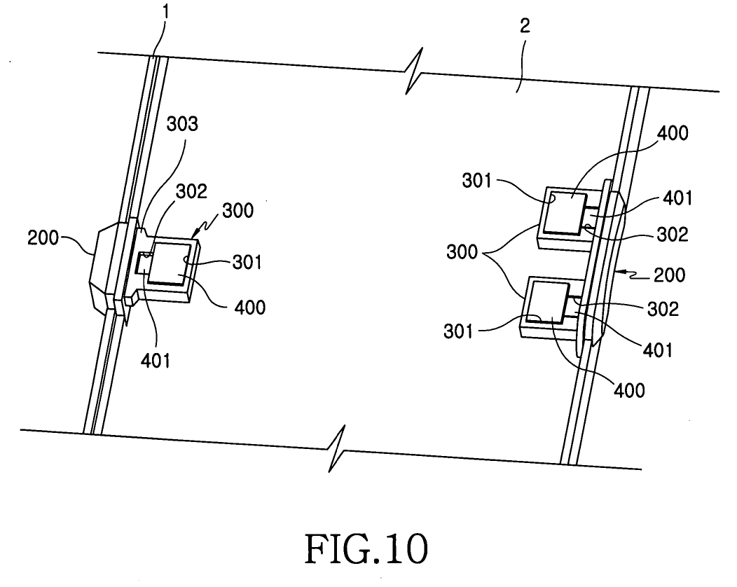

FIG. 10 is a perspective view of a key button device 10 for a portable communication device according to a second preferred embodiment of the present invention.

As shown in FIG. 10, the key button device 10 comprises two key parts 200, three key support parts 300, and three switch parts 400.

As shown in FIG. 10, the switch parts 400 are mounted at both sides of the printed circuit board 2, respectively, and the key support parts 300 are coupled with the switch parts 400 while the key support parts 300 surround the switch parts 400, respectively.

The key support parts 300 are provided with insertion holes 302, into which insertion portions 401 of the switch parts 400 are inserted, respectively.

One of the key support parts 300 is provided with an engagement portion 303, which is detachably engaged into the engagement hole 201 formed at the rear surface of the key part 200. Consequently, the key support part 300 is attached to the key part 200 by inserting the engagement portion 303 of the key support part 300 into the engagement hole 201 of the key part 200.

The key support parts 300 are also provided with engagement holes 301, into which the switch parts 400 are engaged, respectively. Consequently, the switch parts 400 are engaged with the key support parts 300 by inserting the switch parts 400 into the engagement holes 301 of the key support parts 300.

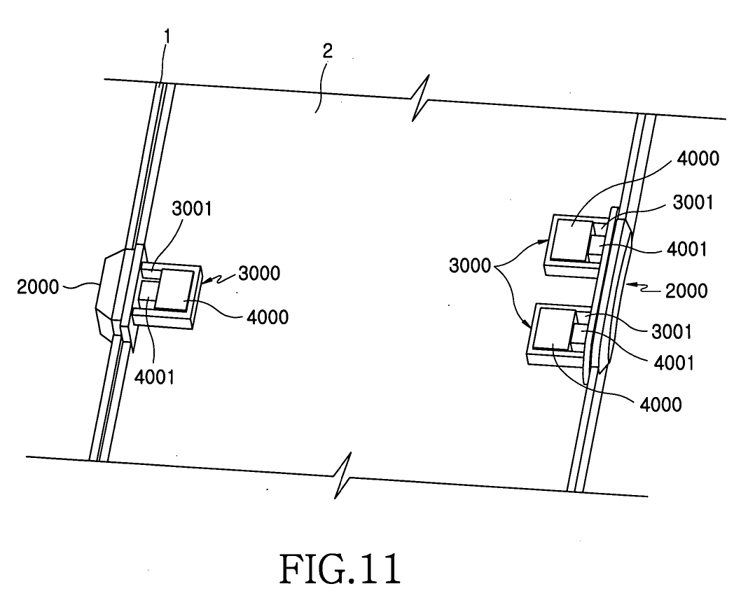

FIG. 11 is a perspective view of a key button device for a portable communication device according to a third preferred embodiment of the present invention.

As shown in FIG. 11, key support parts 3000 are formed integrally with the rear surfaces of key parts 2000 attached to the casing frame 1, respectively.

The key support parts 3000 are coupled with the switch parts 4000, which are mounted on the printed circuit board 2, while the key support parts 3000 surround the switch parts 4000, respectively.

The key support parts 3000 are provided with engagement holes 3001, into which the switch parts 4000 are engaged, respectively.

Insertion portions 4001 formed at the switch parts 4000 are also inserted into the engagement holes 3001 of the key support parts 3000, respectively.

In this way, the key parts 20, 200 or 2000 are tightly attached to the switch parts 40, 400 or 4000 by means of the key support parts 30, 300 or 3000 formed integrally to the rear surfaces of key parts 20, 200 or 2000, respectively. Consequently, a pressing operation of the side keys is smoothly carried out, and tactile sensation of clicking the side keys is good. It will be recognized that the key button device of the present invention is applicable to all kinds of portable communication terminals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A key button device equipped in a casing frame of a portable communication terminal, comprising:
at least one key part attached to the casing frame;
at least one switch part mounted on a printed circuit board in the casing frame; and
at least one key support part attached to the key part and coupled with the switch part, the key support part surrounding the switch part.

2. The device as set forth in claim 1, wherein the key part comprises a keypad and side keys used to operate the portable communication terminal.

3. The device as set forth in claim 1, wherein the key support part is made of rubber.

4. A key button device equipped in a casing frame of a portable communication terminal, comprising:
at least one key part attached to the casing frame;
at least one switch part mounted on a printed circuit board in the casing frame; and
at least one key support part detachably attached to the key part and coupled with the switch part, the key support part surrounding the switch part.

5. The device as set forth in claim 4, wherein the key part comprises a keypad and side keys used to operate the portable communication terminal.

6. The device as set forth in claim 4, wherein the key part has an engagement hole formed in a surface thereof adjacent to the key support part.

7. The device as set forth in claim 4, wherein the key support part is provided with an engagement hole formed so that the switch part is engaged into the engagement hole of the key support part while the key support part surrounds the switch part.

8. The device as set forth in claim 7, wherein the engagement hole of the key support part includes an insertion hole formed so that an insertion portion formed at the switch part is engaged into the insertion hole while the key support part surrounds the switch part.

9. The device as set forth in claim 6, wherein the key support part is further provided with an engagement portion, the engagement portion being engaged into the engagement hole of the key part.

10. A key button device equipped in a casing frame of a portable communication terminal, comprising:
at least two key parts attached to opposite sides of the casing frame, respectively;
at least two switch parts mounted on a printed circuit board in the casing frame; and
at least two key support parts attached to the key parts and coupled with the switch parts, the key support parts surrounding the switch parts, respectively.

11. The device as set forth in claim 10, wherein the at least two key parts comprise side keys used to operate the portable communication terminal.

12. The device as set forth in claim 10, wherein the key support parts are provided with engagement holes formed so that the switch parts are engaged into the engagement holes of the key support parts while the key support parts surround the switch parts, respectively.
